(19) United States
(12) Patent Application Publication
(10) Pub. No.: US 2024/0411303 A1
(43) Pub. Date: Dec. 12, 2024

(54) INDUSTRIAL POWER GENERATION FAULT ADVISORY SYSTEM

(71) Applicant: Mitsubishi Power Americas, Inc., Lake Mary, FL (US)

(72) Inventors: Brian Burgess, Lake Mary, FL (US); Alireza Javanshir, Lake Mary, FL (US); Justin Bosnoian, Lake Mary, FL (US); Jesse Sewell, Lake Mary, FL (US)

(21) Appl. No.: 18/207,884

(22) Filed: Jun. 9, 2023

(51) Int. Cl. G05B 23/02

(52) U.S. Cl. CPC G05B 23/0283; G05B 2223/02

(57) ABSTRACT

Systems and techniques may generally be used for providing an advisory or action regarding a fault or alert for an industrial power generation system. An example technique may include receiving a set of sensor data and identifying an alert related to a subsystem of the industrial power generation system. The example technique may include predicting a root cause of the alert using a similarity match evaluation or using a machine learning trained model for at least one expected value and an actual value from the set of sensor data. The example technique may include determining, based on the predicted root cause, a recommended action and outputting the recommended action.

### BACKGROUND

Power generation and energy storage solutions, such as natural gas, steam, and aero-derivative turbines, power trains and power islands, geothermal systems, solar power, and environmental controls are used worldwide in a variety of settings. Gas turbine engines, for example, operate by passing a volume of gases through a series of compressors and turbines in order to produce rotational shaft power. High energy gases rotate a turbine to generate the shaft power. The shaft power drives a compressor to provide compressed air to a combustion process that generates the high energy gases for turning the turbine. The shaft power can also be used to drive an electrical generator. Industrial power generation systems use sensors to provide telemetry data.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an industrial power generation fault advisory system in accordance with some embodiments.

FIG. 2 illustrates an industrial power generation fault advisory flow diagram in accordance with some embodiments.

FIG. 3 illustrates a predictive analytics block diagram in accordance with some embodiments.

FIG. 4 illustrates a machine learning engine for training and execution related to generating a fault advisory for an industrial power generation system in accordance with some embodiments.

FIG. 5 illustrates a flowchart showing a technique for generating a fault advisory for an industrial power generation system in accordance with some embodiments.

FIG. 6 illustrates generally an example of a block diagram of a machine upon which any one or more of the techniques discussed herein may perform in accordance with some embodiments.

### DETAILED DESCRIPTION

The systems and techniques described herein provide a fault advisory for an industrial power generation system. The fault advisory may include a root cause alert related to a fault occurring at the industrial power generation system. The industrial power generation system may include a turbine, a power train or power island, a geothermal system, a solar power generation system, or the like. The industrial power generation system may include subsystems, such as a compressor, an air duct, a cooling component, a combustor, etc.

The systems and techniques described herein may use information received from one or more sensors to generate a set of sensor data related to at least one subsystem of the industrial power generation system. A database may store a set of expected values, for example related to past or predicted values from the one or more sensors. The expected values may include a range, an average, etc. Processing circuitry may be used to receive identification of an alert, identified from the set of sensor data, related to the at least one subsystem of the industrial power generation system. In some examples, the alert may be triggered when a value from the set of sensor data deviates from the expected values in the database. For example, when a value is outside a database stored range or deviates from a database stored value by more than a threshold, an alert may be triggered. In response to the alert being triggered, a root cause of the alert may be predicted, such as by using a similarity match evaluation between at least one expected value retrieved from the set of expected values stored in the database, and an actual value from the set of sensor data. Based on the predicted root cause, a recommended action may be determined, and optionally output (e.g., stored to the database, displayed, etc.).

An advisory engine may be used to provide advanced analytics including fault detection. In some examples, normal process conditions from which an abnormal event can be detected may be referred to as an “alert”. A technological problem arises in what is to occur after the alert. Typical anomaly detection algorithms stop at detecting a problem and do not provide any insights into what caused the event, why it occurred, or what can resolve the condition. Instead, it is left to a human subject matter expert to review that data and interpret results. This may lead to delays in fixing an issue, which can cause compounding or cascading problems. The human approach is also subjective and may not provide consistency or accuracy. Further problems occur where a false positive, false negative, or faulty alarm occurs and the human is not able to determine the cause. In some examples, notifications are generic, factual, or only offer information about the exact instrument or piece of data which caused the alert.

The currently described systems and techniques provide technical solutions to these technological problems by determining and outputting a root cause of an alert. These systems and techniques may provide insight into a severity of the condition, aid in diagnostics or troubleshooting the problem (diagnostic), offer a recommend action to rectify an issue (e.g., a prescriptive solution), provide information about timeliness of a recommendation action (e.g., a prognostic solution such as mean time to failure), or the like. After a fault has been detected (e.g., an alert occurs), an automated system may provide information related to the fault condition. The information may be dynamic, changing over time, based on current information, tailored to a particular user, or the like. After an analytics or other model determines that there is a change in behavior of a process or system, information specific to a particular condition may be dynamically provided to guide operations or maintenance personnel on a recommended course of action. The systems and techniques may use Failure Mode and Effects Analysis (FMEA) or other information (e.g., in an engineering-controlled document) to provide the recommendation. The recommendation may include diagnostic, prognostic, or prescriptive guidance. The recommendation may include a real time update of a progressing condition with an actionable insight. Information may be controlled, tailored, or delivered to a specific resource or stakeholder. The recommendation may be generated dynamically from content maintained in a database.

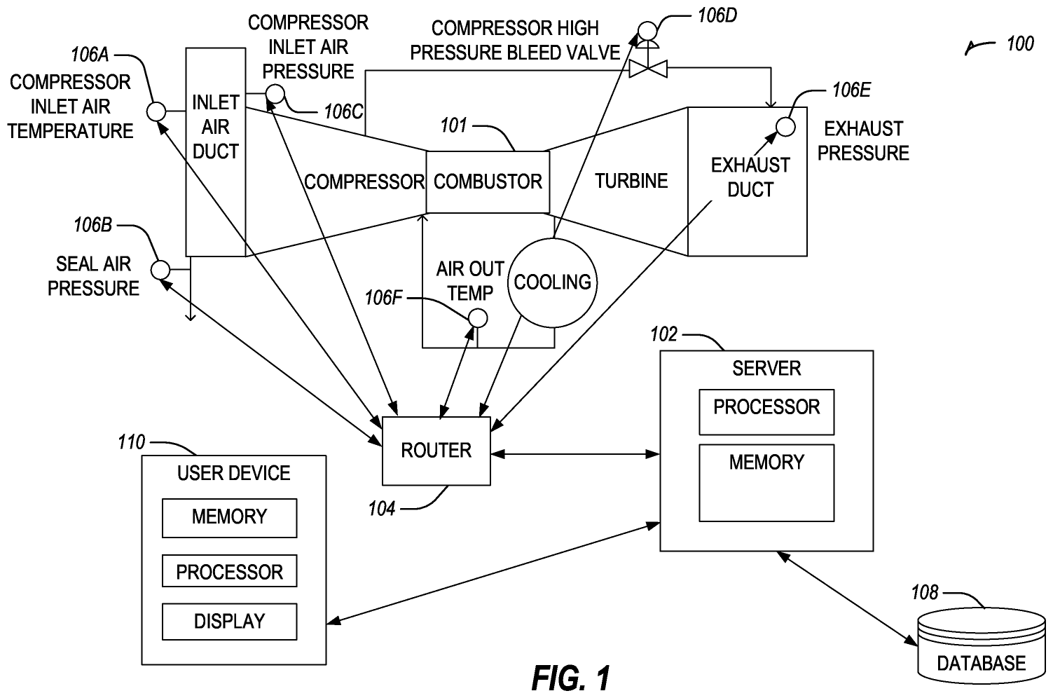

FIG. 1 illustrates an industrial power generation fault advisory system 100 in accordance with some embodiments. The industrial power generation fault advisory system 100 includes an example power generation system 101 (e.g., an air and flue gas system, a turbine cooling air system, etc.). The power generation system 101 includes one or more subsystems, such as an inlet air duct, a compressor, a combustor, a turbine, an exhaust duct, a cooling subsystem, etc. One or more sensors may be used to capture telemetry data for the power generation system 101. A sensor may monitor a dedicated subsystem, may monitor a combination of subsystems, or may monitor the power generation system 101 as a whole. In the power generation system 101 shown in FIG. 1, for example, a set of components includes a compressor inlet air temperature sensor 106A, a seal air pressure sensor 106B, a compressor inlet air pressure sensor 106C, a compressor high pressure bleed valve 106D, an exhaust pressure sensor 106E, and an air out temperature sensor 106F. These sensors are shown as an example, but more or fewer (e.g., one or more) may be used with the systems and techniques described herein.

The one or more sensors 106A-F may communicate with a router 104 to send data to a server 102. The router 104 may include a set of routers (e.g., one or more of the sensors 106A-F may have different routers, which may be dedicated, coordinated, or the like). In some examples, a sensor may act as a router, collecting or forwarding data from another sensor. Reference to the router 104 may include any device configured to send data to the server 102 from a sensor (e.g., may include a repeater, a wireless or wired bus, a wire, a connector, a dedicated device, or the like). In some examples, the sensors 106A-F (e.g., one or more of the sensors 106A-F), the router 104, or the server 102 may modify data captured by the sensors 106A-F. For example, the sensors 106A-F may capture telemetry data, which may be reformatted or processed at one or more of the sensors 106A-F, the router 104, or the server 102. Reformatting or processing data may include collecting data for sending in bulk (e.g., a timeseries of data), performing a mathematical or statistical analysis on the data (e.g., averaging, generating a range, etc.) for sending, or the like. One or more aspects of the techniques described herein (e.g., generating a root cause, fault detection, alerting, etc.) may be performed by any of one or more of the sensors 106A-F), the router 104, the server 102, or a combination thereof.

In an example, data sent to the server 102 from the one or more of the sensors 106A-F (e.g., via the router 104) may be sent to a database 108 for storage. In some examples, the data may be processed by the server 102 (e.g., using a processor or memory of the server 102) before sending to the database 108. The database 108 may be located on the server 102, be remote to the server 102, include multiple databases, etc.

A user device 110 may be used to request or receive information related to the power generation system 101. The information may be received by the user device 110 on request (e.g., via an application programming interface (API), periodically (e.g., every minute, using a subscription service, or the like), in response to an alert, in response to a change to a recommended action or a root cause, or the like. The user device may include memory, a processor, and a display to present the received information. The information may be in a particular format, such as a fixed format document (e.g., a PDF). The fixed format document may be generated at the server 102 from information stored in the database 108, for example in response to an alert. The alert may be generated at the server 102 or elsewhere (e.g., another server for alert detection) based on information received from the one or more sensors 106A-F.

In some examples, multiple subsystems may be affected by an issue or alert, but not all subsystems may react at a same speed. This means that one of the sensors 106A-F may indicate an alert first, but not be the only fault identified over time. This time component may cause a root cause fault or recommendation to change over time. The server 102 may continuously or periodically update a root cause or recommendation in response to a change in alert status or data from one or more of the sensors 106A-F over time. As the effects of the issues propagate out, the server 102 may update a probability of a root cause with the new information. The server 102 may use historical event data or subject matter expert labeled input data to calculate probabilities. This allows the server 102 to provide intelligent insights to rare or unlikely problems as well as known and frequent problems.

In some examples, a template may be used that includes details populated from technical failure or events stored in the database 108. A template may be created for different types of end users. Adding a new user or updating an existing user's preferences may be done by creating or updating a single template, in some examples. The diagnostic modelling approach used by the server 102 may be based on information stored in the database 108 and information received from a sensor (e.g., 106A-F). This allows for inclusion of non-model information for context or education. Results output by the server 102 may be refined as new information becomes available. The server 102 may send an advisory card to the user device 110 with a recommendation, a root cause, an alert, a subsystem affected, or the like. The advisory card may be a dynamically generated document based on an engineering metadata file. The advisory card may include custom-tailored information to accommodate different user roles or responsibilities of a user of the user device 110.

The server 102 may improve a recommendation model based on reinforcement learning, for example. The recommendation model may be updated with each maintenance activity, in some examples. Updates to the recommendation model may occur based on similarly deployed in power generation systems. For example, a recommendation or root cause change identified at a first power generation system may be sent for integrating into a recommendation model at a second power generation system.

The database 108 may be built on a fault matrix shown as Table 1 below. The fault matrix may include one or more of the following information: a list of all possible faults for a system that can be detected by a virtual model, a list of recommended actions and inspection methods (IM) for each fault, a list of all variables that can be predicted by the virtual model, Bij: expected behavior of sensor/variable i when there is fault j (e.g., may be residual of expected value vs. actual value, or an absolute value), or Cij: assigned coefficient when expected behavior of sensor/variable i is happened by fault j (e.g., where the significance of Cij is relative to other Cij in the same column). The rows of Table 1 show faults propagating across and the columns show sensor or variable data propagating down Table 1.

TABLE 1

| | | List of | List of | List of | List of |
|---|---|---|---|---|---|
| | | Recommended | Recommended | Recommended | Recommended |
| | | Actions 1 | Actions 2 | Actions . . . | Actions M |
| | Inspection | IM1 | IM2 | IM . . . | IMM |
| | Method | | | | |
| | Confident | M = 2 | M = 2 | H = 3 | H = 3 |
| | Score | | | | |
| Assigned | Faults | Faults | Faults | Faults | Faults |
| Models | | | | | |
| Model_A | Sensor/ | Expected | | | |
| | Variables | Behavior & | | | |
| | | Coefficient | | | |
| Model_B | Sensor/ | BNM, CNM | | | |
| | Variables | | | | |
| Model_C | Sensor/ | | | | |
| | Variables | | | | |
| Model_D | Sensor/ | | | | |
| | Variables | | | | |

Table 2 below shows an example implementation of fault detection and a recommended action determination:

TABLE 2

| Sensor | Alerts | Fault 1 | Fault 2 | Fault 3 | Fault 4 |
|---|---|---|---|---|---|
| S1 | No | No Change, 1 | No Change, 1 | No Change, 1 | No Change, 1 |
| S2 | Yes, Decrease | Decrease, 2 | Decrease, 2 | No Change, 0 | No Change, 0 |
| S3 | No | No Change, 1 | No Change, 1 | Decrease, 0 | No Change, 0 |
| S4 | Yes, Increase | Increase, 2 | No Change, 0 | Increase, 2 | Increase, 2 |
| S5 | No | Increase, 0 | Increase, 0 | Decrease, 0 | Decrease, 0 |
| S6 | No | Decrease, 0 | No Change, 1 | Increase, 0 | No Change, 1 |
| S7 | No | No Change, 1 | Increase, 0 | No Change, 1 | Increase, 0 |
| S_j | | 0.71 | 0.41 | 0.32 | 0.52 |
| P_j | | 0.35 | 0 | 0 | 0.57 |

A similarity match evaluation may be made (e.g., at server 102) between expected and actual behaviors of a system. For example, when Obᵢ=Bᵢⱼ Then CCᵢⱼ=Cᵢⱼ else CCᵢⱼ=0. Where: Bᵢⱼ is an expected behavior of sensor/variable i when there is fault j, OBᵢ is an observed behavior of sensor/variable I, and CCᵢⱼ is a calculated coefficient for the observed behavior of sensor/variable i related to fault j.

Coefficients may be assigned to similarity scores using Equation 1:

$${S}_{j} = \frac{{\sum }_{i = 1}^{N} {CC}_{ij}}{{\sum }_{i = 1}^{N} {C}_{ij}} \leq 1 for each j . \qquad Equation 1$$

Where Sⱼ is a similarity score of fault j and CFⱼ is a confidence score of fault j. Then, a set of highest scores (in this example five) may be selected and normalized using Equation 2 below:

$${P}_{j} = \frac{{S}_{j} * {CF}_{j} * {W}_{j}}{{\sum }_{j = 1}^{M} {S}_{j} * {CF}_{j} * {W}_{j}} \qquad Equation 2$$

In Equation 2, Wⱼ is a levelized weight of fault j. After determining the selected and normalized set of highest scores, they may be reported as probabilities. These probabilities may be stored in the database 108. These probabilities may be used to generate a report for displaying at the user device 110.

An example report (also called an advisory card) may include information such as an identified alert, an identified system or subsystem, an event description (e.g., “An advisory is activated because the difference between the actual and predicted values of one of the points listed in the below table reached the threshold for the listed advisory window.”), a table of data points indicating an alerting category (e.g., a threshold), an event (e.g., outside the threshold), and a subsystem identifier, a list of one or more possible causes, a list of one or more recommended actions corresponding to the one or more possible causes (which may include historical cause or recommendation information where a cause or recommendation changes, in some examples), a probability of the one or more possible causes, an inspection method (e.g., offline or online), an analytical model of the system or subsystem, a list of one or more sensors or components affecting an alert, a boundary of an alerting subsystem, reference information, or the like. An example portion of a report is shown in Table 3:

TABLE 3
POSSIBLE CAUSES AND RECOMMENDED ACTIONS:

| | | | | Inspection |
|---|---|---|---|---|
| | Possible Cause | Probability | Recommended Actions | Method |
| 1 | Cooler Feed | 73% | 1) Check valve | Online |
| | Water Leak | | 2) Check system | |
| | | | pressure at cooler | |
| 2 | Pressure | 9% | 1) Modify pressure to | Online/ |
| | controller | | see if change results | Offline |
| | | | 2) Replace pressure | |
| | | | controller chip | |
| 3 | Water Pressure | 4% | 1) Visually inspect | Online |
| | Sensor Issue | | sensor. | |
| | | | 2) Check nearby | |
| | | | sensors for accuracy. | |

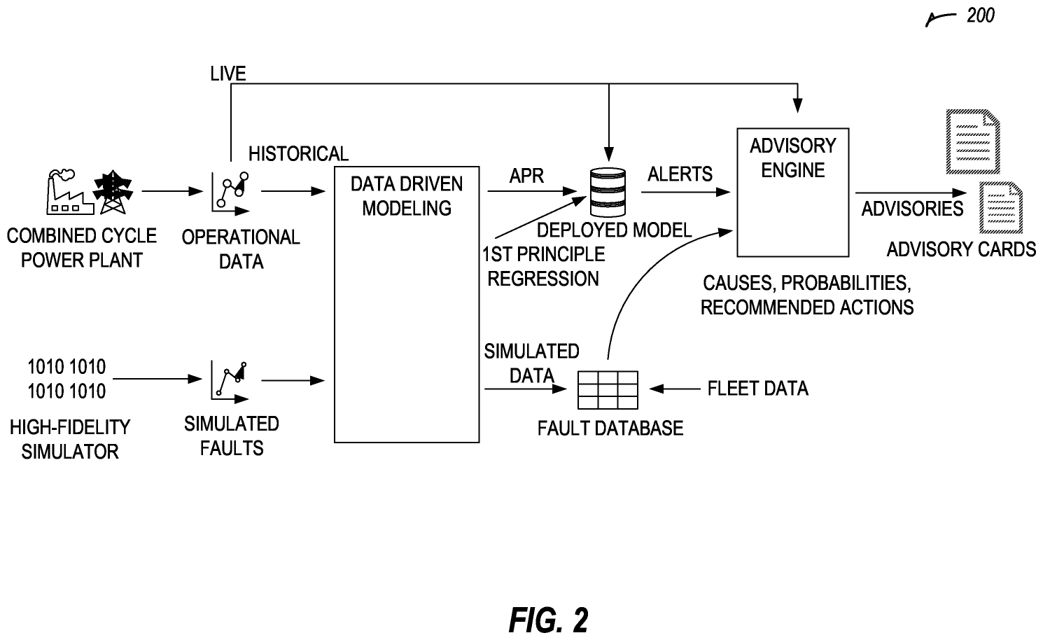

FIG. 2 illustrates industrial power generation fault advisory flow diagram 200 in accordance with some embodiments. The flow diagram 200 illustrates how data moves from an industrial power system until a recommendation or root cause (e.g., displayed on an advisory card) is output. The flow diagram 200 shows two flows, one from a combined cycle power plant (or other power generation system), which generates operational data (including historical data) that may be used by one or more data driven models (e.g., engineering models such as Advanced Pattern Recognition (APR) (e.g., Multivariate State Estimation Technique (MSET)) regression, 1 st principle, thermal performance, model inputs and outputs, model validation, etc.) to predict normal equipment behavior or performance. The second flow may use a high-fidelity simulator to simulate faults, which may be used with the engineering models to generate simulated data. The first flow may identify one or more alerts, which are fed as labels into an advisory engine (e.g., a model, a classifier, a machine learning model, etc.). The simulated data from the second flow may be saved in a fault database (which may include optionally, fleet data), and output to the advisory engine. An alert may be generated when current operation deviates from predicted, normal, operation (residual analysis). The advisory engine may perform root cause analysis and transform an alert into intelligent insights. The advisory engine may output a cause of an alert or fault, a probability, a recommended action, supplemental information, a probability, a confidence score, or the like. These advisories may be output as an advisory card. An advisory card may include a system description, insights, operations and maintenance (O&M) or piping and instrumentation diagram (P&ID) reference, a troubleshooting action, or the like.

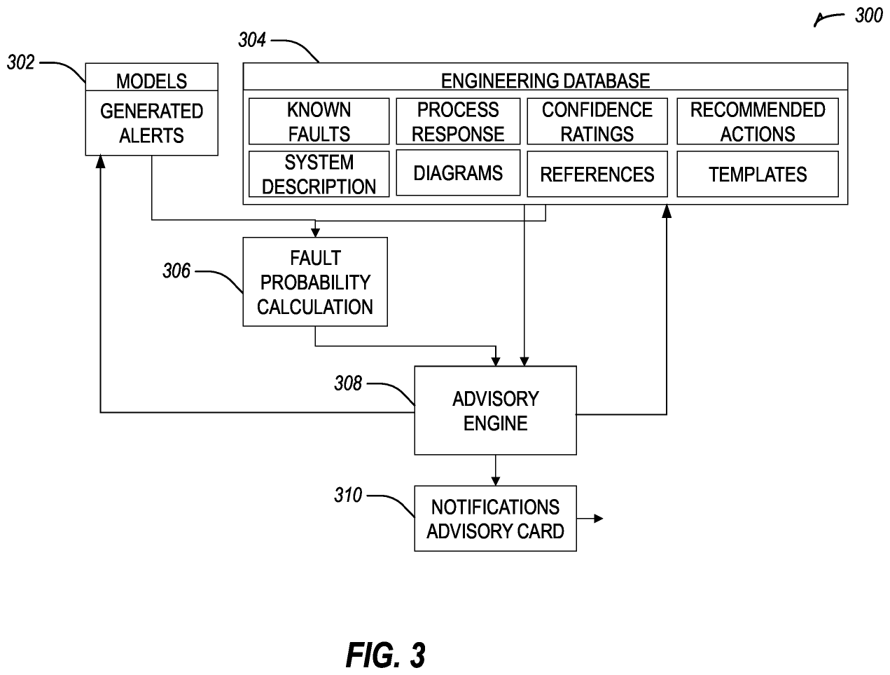

FIG. 3 illustrates a predictive analytics block diagram 300 in accordance with some embodiments. The block diagram 300 illustrates an anomaly detection system, which includes models 302. The models 302 may output a predicted value, which may be compared to an observed value. When the difference between the predicted value and the observed value traverses a threshold, for example, one or more alerts may be generated. The block diagram 300 includes an engineering database 304, which may output a fault probability calculation 306, an advisory engine 308, and one or more notifications 310, such as an advisory card.

The engineering database 304 (which may be the database 108 of FIG. 1) includes information such as known faults, process response, confidence ratings, recommended actions, a system description, diagrams, references, templates, or the like. When an alert is generated, a fault probability calculation may be performed at block 306 using the alert and information from the engineering database 304. The advisory engine 308 may use the fault probability calculation 306 and information from the engineering database to generate information related to the alert (e.g., from the one or more models 302). The advisory engine 308 may output the information related to the alert (e.g., for generating an advisory card at block 310). In some examples, the advisory engine 308 may output information related to the alert to the one or more models 302 or back to the engineering database 304, for example to improve the one or more models 302 or for various historical data stored in the database 304. A model of the one or more models 302 may include an analytical model for anomaly detection, which may include trip and runback protection, a thermal performance model for performance monitoring to detect recoverable performance losses or performance predictions, a mechanical life model for condition-based maintenance (CBM), or the like.

An example sequence of fault alerts (e.g., output from the notifications 310 block) is shown below:

TABLE 4
COMPONENT PRESSURE-1 decrease

| Possible Cause | Probability |
|---|---|
| Pressure-1 Fault 1 | 86% |
| Fault 2 | 14% |

TABLE 5
COMPONENT PRESSURE-2 decrease

| Possible Cause | Probability |
|---|---|
| Sensor 1 Issue | 26% |
| Sensor 2 Issue | 26% |
| Fault 3 | 24% |

TABLE 6
COMPONENT PRESSURE-3 decrease

| Possible Cause | Probability |
|---|---|
| Fault 4 | 44% |
| Fault 5 | 18% |
| Sensor 3 Issue | 15% |

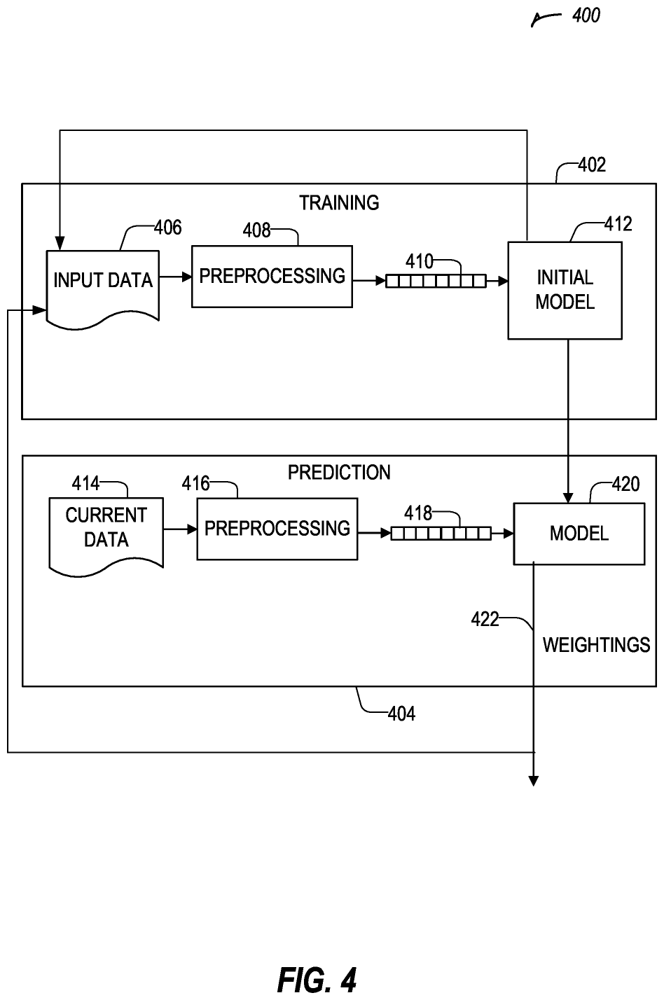

FIG. 4 illustrates a machine learning engine 400 for training and execution related to generating a fault advisory for an industrial power generation system in accordance with some embodiments. The machine learning engine 400 may be deployed to execute at a mobile device (e.g., a cell phone) or a computer (e.g., an orchestrator server). A system may calculate one or more weightings for criteria based upon one or more machine learning algorithms. FIG. 4 shows an example machine learning engine 400 according to some examples of the present disclosure.

Machine learning engine 400 uses a training engine 402 and a prediction engine 404. Training engine 402 uses input data 406, for example, after undergoing preprocessing component 408, to determine one or more features 410. The one or more features 410 may be used to generate an initial model 412, which may be updated iteratively or with future labeled or unlabeled data (e.g., during reinforcement learning or other retraining), for example to improve the performance of the prediction engine 404 or the initial model 412. An improved model may be redeployed for use.

The input data 406 may include information provided by a subject matter expert or historical data for a system or subsystem. The input data 406 may include an example or historical information related to an alert, a recommendation, a fault, sensor data, or the like.

In the prediction engine 404, current data 414 (e.g., sensor data, telemetry data, modified data, etc.) may be input to preprocessing component 416. In some examples, preprocessing component 416 and preprocessing component 408 are the same. The prediction engine 404 produces feature vector 418 from the preprocessed current data 414, which is input into the model 420 to generate one or more criteria weightings 422. The criteria weightings 422 may be used to output a prediction, as discussed further below. In some examples, the criteria weightings 422 may be weighted based on a similarity score. The weightings 422 may be normalized. The weightings 422 may include fixed values stored in a database generated by subject matter experts or historical data. For unknown issues or faults (e.g., or corresponding alerts), a low weight may be used, since it is unlikely to happen, or where there is no or limited information available about the issue, fault, or alert. A fault determination or recommendation technique may be triggered based on an alert, and in some examples all faults may be continuously assigned zero weights until an alert occurs.

The training engine 402 may operate in an offline manner to train the model 420 (e.g., on a server). The prediction engine 404 may be designed to operate in an online manner (e.g., in real-time, at a mobile device, on a wearable device, etc.). In some examples, the model 420 may be periodically updated via additional training (e.g., via updated input data 406 or based on labeled or unlabeled data output in the weightings 422) or based on identified future data, such as by using reinforcement learning to personalize a general model (e.g., the initial model 412) to a particular user, system, subsystem, or location.

Labels for the input data 406 may include expected behaviors of a system or subsystem. In some examples, the labels may include a root cause fault, a recommendation, or the like.

The initial model 412 may be updated using further input data 406 until a satisfactory model 420 is generated. The model 420 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 402 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 402. In an example embodiment, a regression model is used and the model 420 is a vector of coefficients corresponding to a learned importance for each of the features in the vector of features 410, 418. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 420 may output a possible cause, a recommended action corresponding to the possible cause, a historical cause or recommendation information where a cause or recommendation changes, a probability of the possible cause or the recommended action (e.g., a probability of success for the recommended action to solve the possible cause), an inspection method (e.g., offline or online), an analytical model of the system or subsystem, one or more sensors or components affecting an alert, a boundary of an alerting subsystem, a cause of an alert or fault, supplemental information, a probability, a confidence score, a personnel impact (e.g., how many workers will be needed to fix or will be idle if something fails) or the like. In some examples, probability values may be output and plotted as a real-time trend. An output may be tailored to a particular user or use case, such as for users in engineering, maintenance, management, sales, etc.

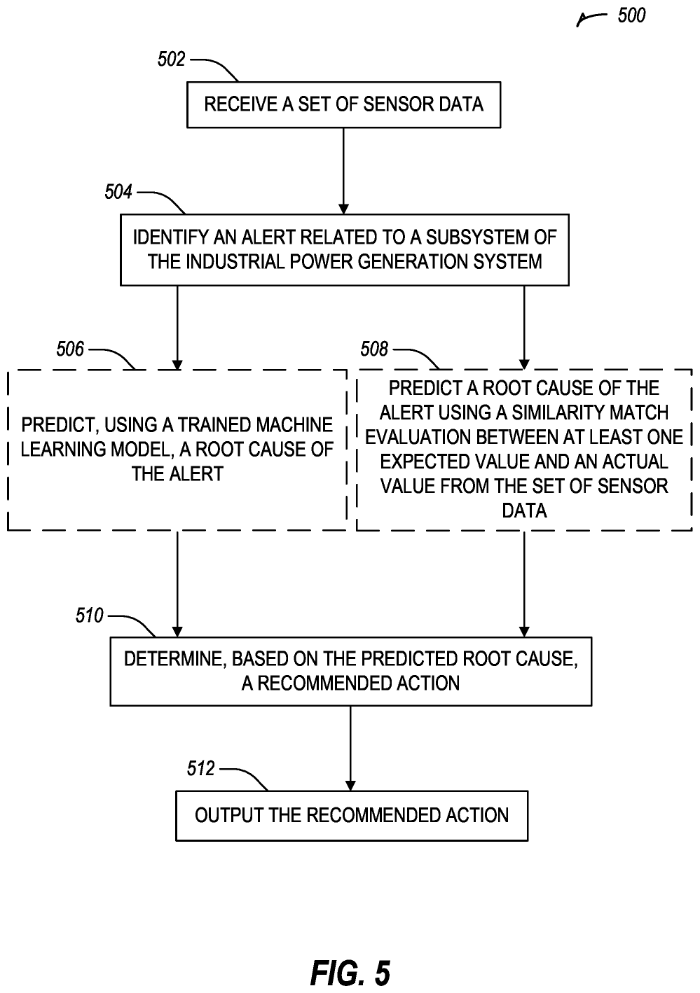

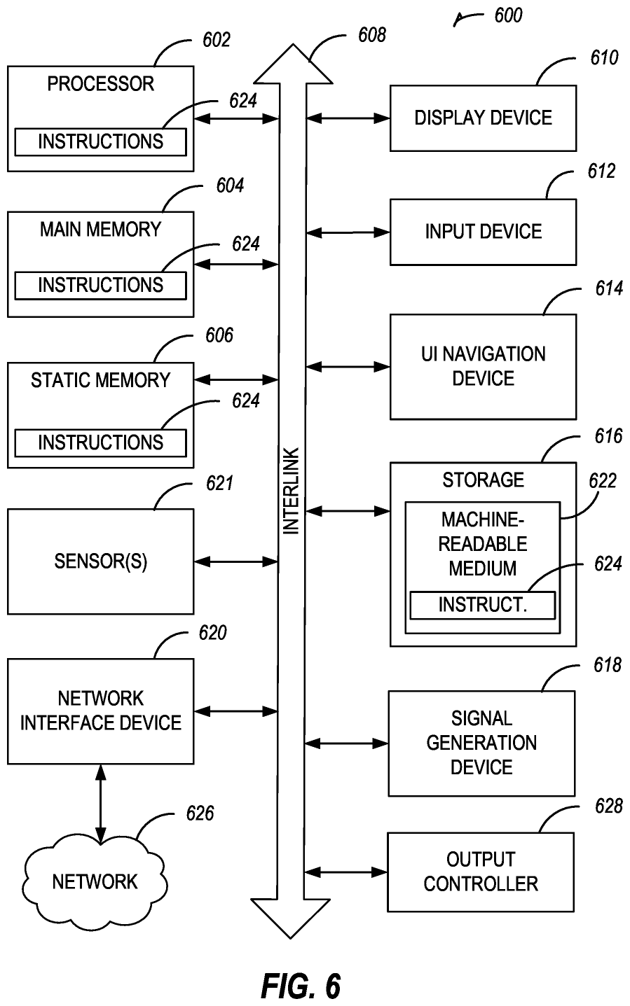

FIG. 5 illustrates a flowchart showing a technique 500 for generating a fault advisory for an industrial power generation system in accordance with some embodiments. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 6.

The technique 500 includes an operation 502 to receive a set of sensor data. The set of sensor data may be collected from sensors 106A-F of the industrial power generation system 101 (see FIG. 1). The set of sensor data may include telemetry data, processed data (e.g., a time series, an average, a sample, etc.), raw data, or the like.

The technique 500 includes an operation 504 to identify an alert related to a subsystem of the industrial power generation system 101. The subsystem may include at least one of an air and flue gas system, a turbine cooling air system, a blade path, a compressor, an exhaust subsystem, or the like. After operation 504, the technique 500 may proceed with either operation 506, operation 508, or both operations 506 and 508, in either order, before proceeding to operation 510. In an example, an alert may represent a difference between an observed value and an expected value.

The technique 500 includes an operation 506 to predict, using a trained machine learning model, a root cause of the alert. Operation 506 may include comparing the actual value to a set of expected values stored in a database including the at least one expected value. In some examples, the set of expected values may have corresponding weights based on historical data related to the alert. These weights may be set to zero when no alert is active.

The technique 500 includes an operation 508 to predict a root cause of the alert using a similarity match evaluation between at least one expected value and an actual value from the set of sensor data.

The technique 500 includes an operation 510 to determine, based on the predicted root cause, a recommended action.

The technique 500 includes an operation 512 to output the recommended action. In some examples, instead of or in addition to outputting the recommended action, operation 512 may include outputting the predicted root cause. Operation 512 may include saving the recommended action or the predicted root cause to a database, such as the database 304 depicted in FIG. 3. In an example, in response to receiving a user request for information related to the alert, a fixed format document (e.g., a PDF) may be generated using information saved to the database including the recommended action or the predicted root cause. In some examples, an indication of a recipient role in the industrial power generation system may be received. In these examples, the fixed format document may be generated to include information specific to the recipient role. The recipient role may include at least one of an engineering role, a maintenance role, a management role, a sales role, or the like.

The technique 500 may include an operation to receive a second set of sensor data related to the alert. In response to receiving the second set of sensor data, this operation may include using the similarity match evaluation to predict a second root cause different from the root cause. Based on the predicted second root cause, a second recommended action different from the recommended action may be determined. The second recommended action may be output. In some examples of this operation, the similarity match evaluation may be modified using the second recommended action or the predicted second root cause. The technique 500 may include retraining the trained machine learning model such as model 412 of FIG. 4 using the second recommended action or the predicted second root cause.

The technique 500 may be iterated, for example to generate an improved predicted root cause or recommended action, to check for further issues, or the like. For example, the technique 500 may be iterated periodically, such as once every second, once every minute, once every five minutes, etc.

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is at least one machine-readable medium including instructions for monitoring an industrial power generation system, which when executed by processing circuitry, cause the processing circuitry to perform operations to: receive a set of sensor data; identify an alert related to a subsystem of the industrial power generation system; predict a root cause of the alert using a similarity match evaluation between at least one expected value and an actual value from the set of sensor data; based on the predicted root cause, determine a recommended action; and output the recommended action.

In Example 2, the subject matter of Example 1 includes, wherein to predict the root cause using the similarity match evaluation, the instructions further include operations to compare the actual value to a set of expected values stored in a database including the at least one expected value, the set of expected values having corresponding weights based on historical data related to the alert.

In Example 3, the subject matter of Example 2 includes, wherein the weights are set to zero when no alert is active.

In Example 4, the subject matter of Examples 1-3 includes, wherein the instructions further include operations to: receive a second set of sensor data related to the alert; in response to receiving the second set of sensor data, use the similarity match evaluation to predict a second root cause different from the root cause; based on the predicted second root cause, determine a second recommended action different from the recommended action; and output the second recommended action.

In Example 5, the subject matter of Example 4 includes, wherein the instructions further include operations to modify the similarity match evaluation using the second recommended action and the predicted second root cause.

In Example 6, the subject matter of Examples 1-5 includes, wherein the instructions further include operations to output the predicted root cause.

In Example 7, the subject matter of Examples 1-6 includes, wherein to output the recommended action, the instructions further include operations to save the recommended action and the predicted root cause to a database.

In Example 8, the subject matter of Example 7 includes, wherein the instructions further include operations to, in response to receiving a user request for information related to the alert, generate a fixed format document using information saved to the database including the recommended action and the predicted root cause.

In Example 9, the subject matter of Example 8 includes, wherein the instructions further include operations to receive an indication of a recipient role in the industrial power generation system, and wherein the fixed format document includes information specific to the recipient role, the recipient role including at least one of an engineering role, a maintenance role, a management role, or a sales role.

In Example 10, the subject matter of Examples 1-9 includes, wherein to predict the root cause, the instructions further include operations to predict a probability that the root cause caused the alert.

Example 11 is a method for monitoring an industrial power generation system, the method comprising: receiving a set of sensor data; identifying an alert related to a subsystem of the industrial power generation system; using a trained machine learning model, predicting a root cause of the alert; based on the predicted root cause, determining, using processing circuitry, a recommended action; and outputting the recommended action.

In Example 12, the subject matter of Example 11 includes, receiving a second set of sensor data related to the alert; in response to receiving the second set of sensor data, using the trained machine learning model to predict a second root cause different from the root cause; based on the predicted second root cause, determining a second recommended action different from the recommended action; and outputting the second recommended action.

In Example 13, the subject matter of Example 12 includes, retraining the trained machine learning model using the second recommended action and the predicted second root cause.

In Example 14, the subject matter of Examples 11-13 includes, outputting the predicted root cause.

In Example 15, the subject matter of Examples 11-14 includes, wherein outputting the recommended action includes saving the recommended action and the predicted root cause to a database.

In Example 16, the subject matter of Example 15 includes, in response to receiving a user request for information related to the alert, generating a fixed format document using information saved to the database including the recommended action and the predicted root cause.

In Example 17, the subject matter of Example 16 includes, receiving an indication of a recipient role in the industrial power generation system, and wherein the fixed format document includes information specific to the recipient role, the recipient role including at least one of an engineering role, a maintenance role, a management role, or a sales role.

In Example 18, the subject matter of Examples 11-17 includes, wherein the method is iterated periodically and at least once every sixty seconds.

Example 19 is an industrial power generation system comprising: a plurality of sensors to generate a set of sensor data related to at least one subsystem of the industrial power generation system; a database storing a set of expected values; processing circuitry; and memory, including instructions, which when executed by the processing circuitry, cause the processing circuitry to perform operations to: receive identification of an alert, identified from the set of sensor data, related to the at least one subsystem of the industrial power generation system; predict a root cause of the alert using a similarity match evaluation between at least one expected value retrieved from the set of expected values stored in the database, and an actual value from the set of sensor data; based on the predicted root cause, determine a recommended action; and output the recommended action.

In Example 20, the subject matter of Example 19 includes, wherein the instructions further include operations to, in response to receiving a user request for information related to the alert, generate a fixed format document using information saved to the database including the recommended action and the predicted root cause.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. At least one machine-readable medium including instructions for monitoring an industrial power generation system, which when executed by processing circuitry, cause the processing circuitry to perform operations to:
receive a set of sensor data;
identify an alert related to a subsystem of the industrial power generation system;
predict a root cause of the alert using a similarity match evaluation between at least one expected value and an actual value from the set of sensor data;
based on the predicted root cause, determine a recommended action; and
output the recommended action.

2. The at least one machine-readable medium of claim 1, wherein to predict the root cause using the similarity match evaluation, the instructions further include operations to compare the actual value to a set of expected values stored in a database including the at least one expected value, the set of expected values having corresponding weights based on historical data related to the alert.

3. The at least one machine-readable medium of claim 2, wherein the weights are set to zero when no alert is active.

4. The at least one machine-readable medium of claim 1, wherein the instructions further include operations to:
receive a second set of sensor data related to the alert;
in response to receiving the second set of sensor data, use the similarity match evaluation to predict a second root cause different from the root cause;
based on the predicted second root cause, determine a second recommended action different from the recommended action; and
output the second recommended action.

5. The at least one machine-readable medium of claim 4, wherein the instructions further include operations to modify the similarity match evaluation using the second recommended action and the predicted second root cause.

6. The at least one machine-readable medium of claim 1, wherein the instructions further include operations to output the predicted root cause.

7. The at least one machine-readable medium of claim 1, wherein to output the recommended action, the instructions further include operations to save the recommended action and the predicted root cause to a database.

8. The at least one machine-readable medium of claim 7, wherein the instructions further include operations to, in response to receiving a user request for information related to the alert, generate a fixed format document using information saved to the database including the recommended action and the predicted root cause.

9. The at least one machine-readable medium of claim 8, wherein the instructions further include operations to receive an indication of a recipient role in the industrial power generation system, and wherein the fixed format document includes information specific to the recipient role, the recipient role including at least one of an engineering role, a maintenance role, a management role, or a sales role.

10. The at least one machine-readable medium of claim 1, wherein to predict the root cause, the instructions further include operations to predict a probability that the root cause caused the alert.

11. A method for monitoring an industrial power generation system, the method comprising:
receiving a set of sensor data;
identifying an alert related to a subsystem of the industrial power generation system;
using a trained machine learning model, predicting a root cause of the alert;
based on the predicted root cause, determining, using processing circuitry, a recommended action; and
outputting the recommended action.

12. The method of claim 11, further comprising:
receiving a second set of sensor data related to the alert;
in response to receiving the second set of sensor data, using the trained machine learning model to predict a second root cause different from the root cause;
based on the predicted second root cause, determining a second recommended action different from the recommended action; and
outputting the second recommended action.

13. The method of claim 12, further comprising, retraining the trained machine learning model using the second recommended action and the predicted second root cause.

14. The method of claim 11, further comprising, outputting the predicted root cause.

15. The method of claim 11, wherein outputting the recommended action includes saving the recommended action and the predicted root cause to a database.

16. The method of claim 15, further comprising, in response to receiving a user request for information related to the alert, generating a fixed format document using information saved to the database including the recommended action and the predicted root cause.

17. The method of claim 16, further comprising receiving an indication of a recipient role in the industrial power generation system, and wherein the fixed format document includes information specific to the recipient role, the recipient role including at least one of an engineering role, a maintenance role, a management role, or a sales role.

18. The method of claim 11, wherein the method is iterated periodically and at least once every sixty seconds.

19. An industrial power generation system comprising:
a plurality of sensors to generate a set of sensor data related to at least one subsystem of the industrial power generation system;
a database storing a set of expected values;
processing circuitry; and
memory, including instructions, which when executed by the processing circuitry, cause the processing circuitry to perform operations to:
receive identification of an alert, identified from the set of sensor data, related to the at least one subsystem of the industrial power generation system;
predict a root cause of the alert using a similarity match evaluation between at least one expected value retrieved from the set of expected values stored in the database, and an actual value from the set of sensor data;
based on the predicted root cause, determine a recommended action; and
output the recommended action.

20. The industrial power generation system of claim 19, wherein the instructions further include operations to, in response to receiving a user request for information related to the alert, generate a fixed format document using information saved to the database including the recommended action and the predicted root cause.
